(19) United States
(12) Patent Application Publication
(10) Pub. No.: US 2006/0017823 A1
(43) Pub. Date: Jan. 26, 2006

(54) Electronic still camera and method for managing image data

(75) Inventor: Toshihisa Kuroiwa, Miura-shi (JP)

Correspondence Address: OLIFF & BERRIDGE, PLC, P.O. BOX 19928, ALEXANDRIA, VA, 22320, US

(73) Assignee: NIKON CORPORATION, TOKYO (JP)

(21) Appl. No.: 11/234,278

(22) Filed: Sep. 26, 2005

Related U.S. Application Data
(63) Continuation of application No. 10/073,897, filed on Feb. 14, 2002, now abandoned.
Application No. 10/073,897 is a continuation of application No. 09/604,790, filed on Jun. 28, 2000, now abandoned.
Application No. 09/604,790 is a continuation of application No. 08/732,990, filed on Oct. 16, 1996, now abandoned.

(30) Foreign Application Priority Data
Oct. 16, 1995 (JP) 7-266876

(51) Int. Cl. H04N 5/76

(52) U.S. Cl. 348/231.99

(57) ABSTRACT

An electronic still camera embodying the invention converts images of an object into image data and records the image data onto a recording medium. A corresponding identification code is directly recorded with the image data so that the image data can be efficiently managed within the electronic still camera.

### CROSS-REFERENCE TO RELATED APPLICATIONS

This is a Continuation of application Ser. No. 10/073,897 filed Feb. 14, 2002, which in turn is a Continuation of application Ser. No. 09/604,790 filed Jun. 28, 2000 (now abandoned), which is a Continuation of application Ser. No. 08/732,990 filed Oct. 16, 1996 (Now abandoned). The entire disclosures of the prior applications are hereby incorporated by reference herein in their entireties.

### BACKGROUND OF THE INVENTION

1. Field of the Invention

The present invention relates to an electronic still camera which converts an analog object image into digital image data (information) and records the image data in a recording medium. Particularly, it relates to an electronic still camera which efficiently manages the image data in the recording medium.

2. Description of Related Art

Electronic still cameras which record in a recording medium image data photoelectrically converted through a CCD or other image pick-up elements are conventionally known.

FIG. 6 shows an example of a conventionally known electronic still camera.

FIGS. 7(a-c) show examples of conventionally known control members for the electronic still camera of FIG. 6.

In these figures, a shooting lens 11 is mounted on an electronic still camera 10, and a photoreceiving surface of an image pick-up unit 12 is positioned on an optical axis of the shooting lens 11.

Photoelectric output from the image pick-up unit 12 is input to a compression and expansion circuit 15 through an A/D converter 13 and a frame memory 14. Output from the compression and expansion circuit 15 is input to a memory card 17 through an interface 16.

Data from the frame memory 14 is output from a video output terminal 19 through a D/A converter 18, which is connected to an external monitor 20.

A release switch 21, a mode changing switch 22, and a frame advance switch 23 are positioned on a housing of the electronic still camera 10. Each of connecting points for the control members is connected to input terminals of a control circuit 25.

Output terminals of this control circuit 25 are connected to the image pick-up unit 12, the A/D converter 13, the frame memory 14, the compression and expansion circuit 15, the interface 16, the D/A converter 18, and a display device 26.

If the release switch 21 is fully depressed, a normal shooting action is commenced. That is, the control circuit 25 reads image data from the image pick-up unit 12 and accumulates it in the frame memory 14 through the A/D converter 13. The control circuit then compresses this image data and records it in the memory card 17.

On the other hand, if the mode changing switch 22 is set in a “replay mode,” the control circuit 25 displays a frame number in the display device 26 and reads image data corresponding to that frame number from the memory card 17.

The control circuit 25 expands the image data through the compression and expansion circuit 15 and stores the image data in the frame memory 14. When image data for one screen (picture) is accumulated in the frame memory 14, the control circuit 25 successively reads the image data from the frame memory 14 and converts the image data into video signals through D/A converter 18. These video signals are provided to the monitor 20 which replays the image data.

Every time the frame advance switch 23 is turned on, the control circuit 25 increases a frame number by one and replays the image data corresponding to the new frame number.

Because the memory card 17 can be used over and over, running costs are low. With such an advantage, the number of pictures that can be taken is generally higher than in film cameras. Thus a large amount of image data tends to be stored in the memory card 17. As a result, pictures (image data) stored in the memory card 17 include many unsuccessful pictures or test pictures repeated under differing exposure conditions.

Accordingly, it is necessary to periodically clear unnecessary image data from the stored image data. However, there is no space for separately providing a control member for such an operation in the conventionally known electronic still camera 10. The image data is conventionally managed by separately providing a personal computer or other external device.

For example, as shown in FIG. 8, a memory card reader 77 is connected to an external computer 78 or other external device 76. The memory card 17 which is taken out (ejected) from the electronic still camera 10 is mounted (inserted) to the memory card reader 77. The image data is read one by one from the memory card 17 and determined as to whether the image data should be kept or deleted.

Additionally, in a second example, the electronic still camera 10 can be directly connected to the computer 78 to entirely transfer the image data in the electronic still camera 10 from memory card 17. The user can then determine the necessity for each picture after saving the image data from each picture in a hard disk or other large capacity storing device 75 or 76. Data from the memory card 17 could also be read and sent to the computers 78 via a modem 79 and 80.

### SUMMARY OF THE INVENTION

One object of the present invention is to provide an electronic still camera in which image data is selected and a corresponding identification code is directly recorded with the image data. The image data can later be immediately divided based on the identification code to efficiently select the image data. Moreover, the first object of the invention is to provide an electronic still camera which can efficiently manage the image data within the electronic still camera.

Because processes for selecting desired image data or deleting unnecessary image data are not necessary, the later selection of image data can be done quickly.

Furthermore, when failures in shooting are determined at the time of shooting objects, because the identification code is immediately recorded, the image data does not have to be replayed one by one to determine the results of shooting as in conventional electronic still cameras. Thus, the image data can be efficiently and intuitively distinguished.

In addition, because the identification code is written by the electronic still camera, external devices only need to be equipped with circuitry to determine the identification codes; they do not have to be specially equipped with any hardware for image processing.

A second object of the present invention is to provide an electronic still camera in which image data is selected by changing the frame number. Normally, because an operator often recognizes the number of frames that separate a current frame from one in which shooting failures exist, the majority of the image data can be accurately distinguished with only the frame number.

Because the image data is not replayed, the time required for replaying can be saved, and the image data can be quickly and efficiently distinguished.

Furthermore, only two control members relevant to the frame advance means and the manual selection means are required. Accordingly, the number of control members is kept as low as possible.

In addition, in an electronic still camera having the replay function, because the frame advance button that is used when replaying the image data can also be used as a frame advance means when recording the image data, the number of control members is further controlled to be as low as possible.

A third object of the present invention is to provide an electronic still camera in which image data is selected any time while replaying the image data, which can be replayed one by one. The selected image data can then be efficiently and accurately distinguished.

Only one control member relevant to the selecting means is required. Accordingly, the number of control members can be controlled to be as low as possible.

A fourth object of the present invention is to provide an electronic still camera in which codes of the file attributes are changed in accordance with the specified file formats. The image data can then be simply and generally distinguished in external devices using the same file formats.

A fifth object of the present invention is to provide an electronic still camera in which file names or file extensions are changed in accordance with the specified file formats. The image data can then be simply and generally divided in external devices using the same file formats.

As described above, in an electronic still camera according to the present invention, because the image data is immediately divided by the electronic still camera, operations for distinguishing the image data which normally take time when managing the image data can be quickly and efficiently completed.

However, with the conventional electronic still camera 10, because external devices are necessary to manage the image data, there is a problem in that the system structure is complicated.

Furthermore, because the size of the image data is generally large, transferring time is long when transferring the image data from the electronic still camera 10 to the external devices.

In addition, in order to quickly manage the image data in the external device, an expansion process for the image data must be accomplished at high speed, which creates another problem in that improved hardware or increased memory is required to be used exclusively for the imaging processes.

According to the first aspect of the invention, the electronic still camera includes optical means for forming an object image, image pick-up means for photoelectrically converting the object image formed by said optical means to image data, recording means for recording the image data converted by the image pick-up means as a plurality of image data files with file attribute data to a recording medium based on a specified file format, selecting means for selecting at least one selected image data file from the plurality of image data files recorded in the recording medium, wherein the recording means changes a file attribute of the at least one selected image data file.

In accordance with the first aspect of the invention, an operator selects the at least one selected image data file using the selecting means.

The objective of the first aspect of the invention is to provide an electronic still camera which can efficiently manage the image data within the electronic still camera.

According to the second aspect of the invention, the recording means records the image data, file names and file extensions based on the specified file formats, and the recording means also changes the file name and the file extension of the at least one selected image data file. More specifically, the recording means records the image data, the file name, and the file extensions based on the specified file format. The recording means also distinguishes the at least one selected data image file by changing its file attributes or file extensions.

According to the third aspect of the invention, the selecting means in the electronic still camera comprises frame advance means and a manual selection means.

In accordance with the third aspect of the invention, the operator adjusts the frame number at “a frame number of image data desired to be selected” by performing a first external operation with the frame advance means. Next, the operator selects the image data corresponding to the frame number by performing a second external operation with the manual selection means.

The objective of the second and third aspects of the invention is to provide an electronic still camera in which the number of control members is controlled to be as low as possible while the image data is efficiently managed within the electronic still camera.

According to the fourth aspect of the invention, the electronic still camera comprises replaying means for replaying the plurality of image data files recorded in the recording medium, one by one. The selecting means selects at least one of said plurality of image data files being replayed as the at least one selected image data file when an external operation is performed.

In accordance with the fourth aspect of the invention, the image data in the recording medium is replayed one by one by the replaying means.

The operator performs an operation with the selecting means when “the image data desired to be selected” is replayed while confirming the replayed image data. Then, the selecting means is used to select the image data being replayed as the selected image data file.

The recording means records other image data and identifiable codes with respect to the selected image data file selected as described above.

The objective of the fourth aspect of the invention is to provide an electronic still camera which, in addition to the above objectives, can simply and generally distinguish undesired image data from desired image data.

### BRIEF DESCRIPTION OF THE DRAWINGS

A description of preferred embodiments of the invention will be provided in conjunction with the following drawing figures, wherein:

FIG. 1 is a schematic view showing the structures and functions of a first embodiment of the present invention;

FIGS. 2a and 2b are schematic views of control members of the first embodiment of the present invention;

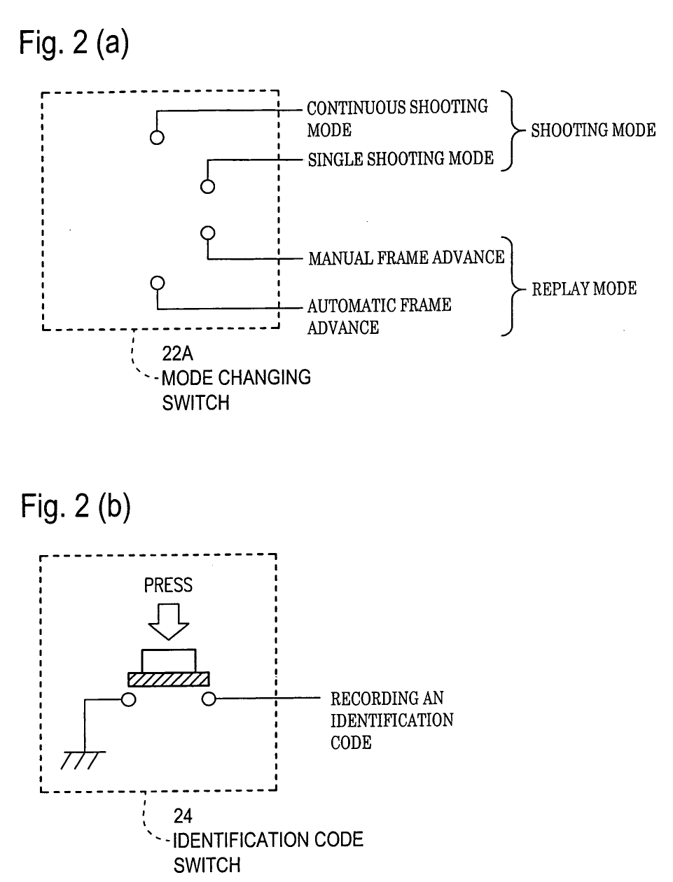

FIG. 3 is a flow chart describing a first operation of the first embodiment of the present invention;

FIG. 4 is a flow chart describing a second operation of the first embodiment of the present invention;

FIG. 5 is a schematic view showing file formats of MS-DOS (TM) files;

FIG. 6 is a schematic view of the structures and functions of a conventional electronic still camera;

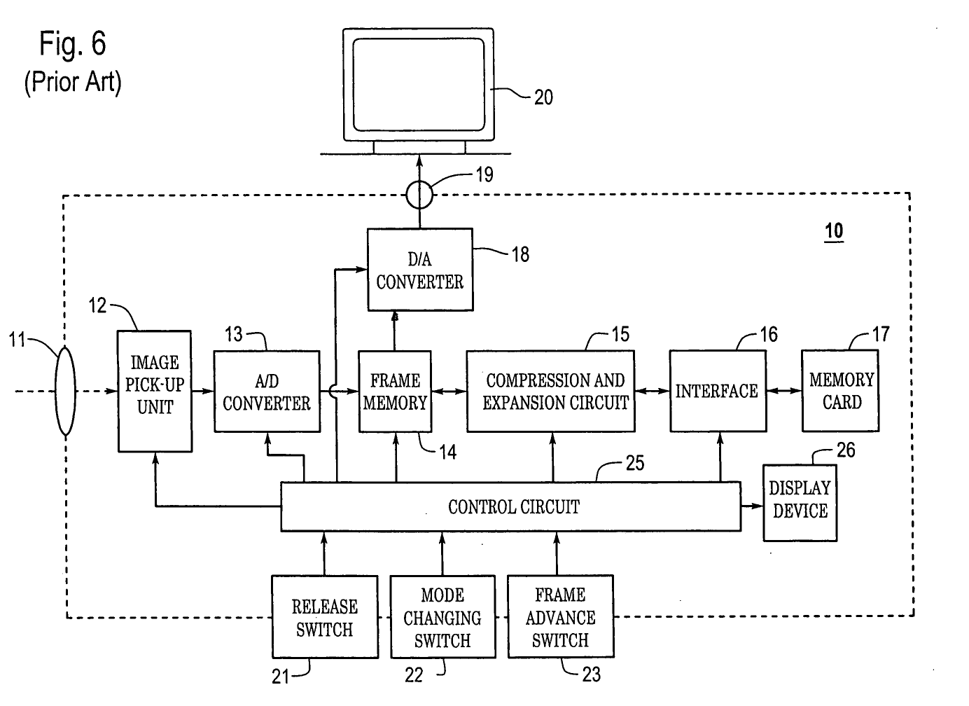

FIGS. 7a, 7b and 7c are schematic views of conventionally known control members; and

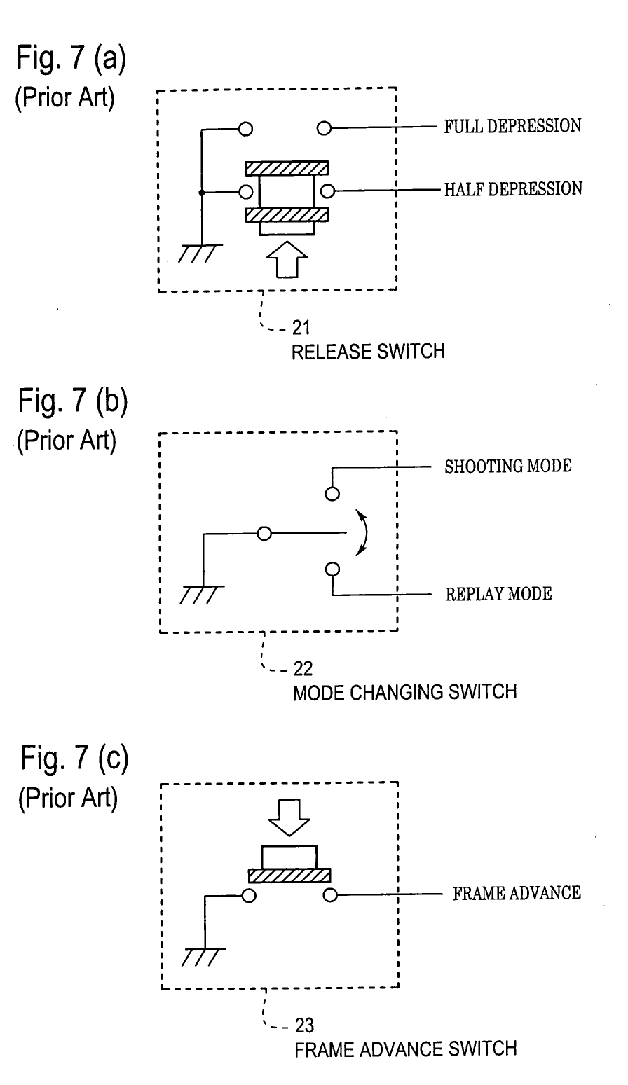

FIG. 8 is a schematic view showing the structures and functions of a conventionally known electronic still camera connected to a computer.

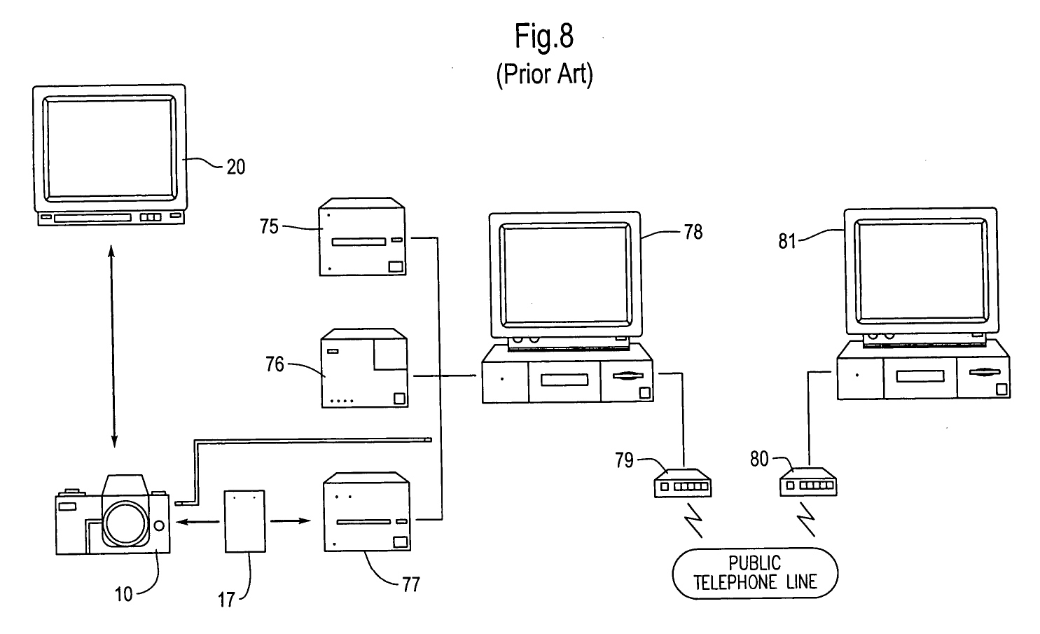

### DETAILED DESCRIPTION OF PREFERRED EMBODIMENTS

Embodiments of the present invention are described hereafter based on the drawings.

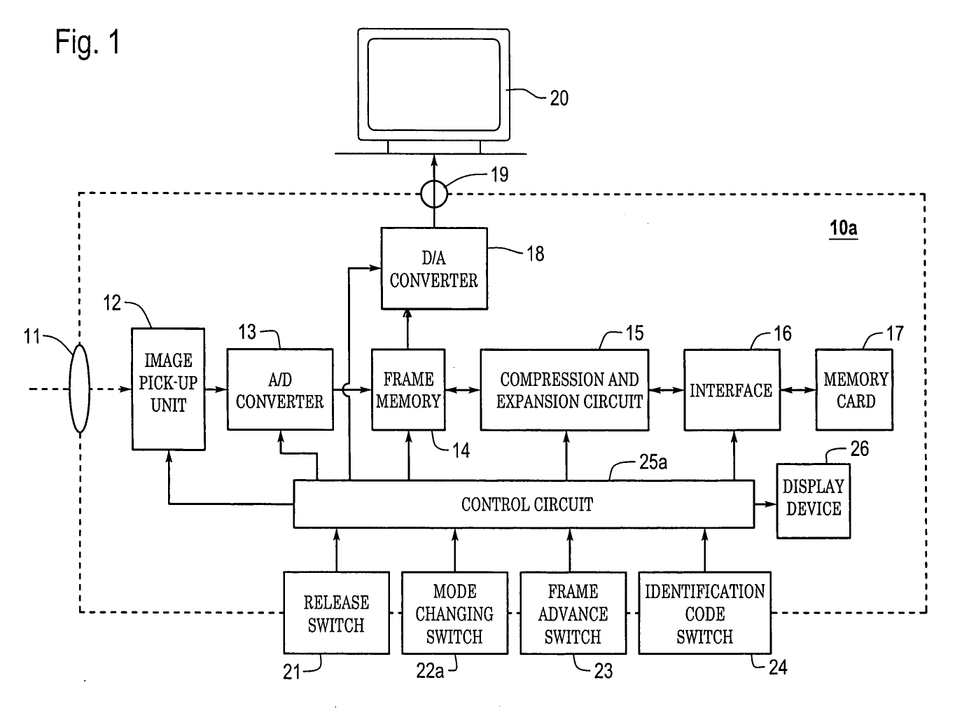

In FIG. 1, a shooting lens 11 is mounted on an electronic still camera 10a. The electronic still camera 10a has an optical axis on which a photoreceptive surface of an image pick-up unit 12 is positioned.

Photoelectric output from the image pick-up device is input into a compression and expansion circuit 15 through an A/D converter 13 and a frame memory 14. Output from the compression and expansion circuit 15 is input to a memory card 17 through an interface 16.

Data output from the frame memory 14 is output to a video output terminal 19 through a D/A converter 18. This video output terminal 19 is connected to an external monitor 20.

Control members comprising a release switch 21, a mode changing switch 22a, a frame advance switch 23, and an identification code switch 24 are positioned on a housing of the electronic still camera 10a. These control members are connected to a control circuit 25a.

An optical means comprises the shooting lens 11; an image pick-up means comprises the image pick-up unit 12; a selecting means comprises the frame advance switch 23, the identification code switch 24, and the control circuit 25a; and a recording means comprises the interface 16 and the control circuit 25a.

A frame advancing means comprises the frame advance switch 23 and the control circuit 25a; and a manual selection means comprises the identification code switch 24 and the control circuit 25a.

A replaying means comprises the interface 16, the frame memory 14, the D/A converter 18 and the control circuit 25a; and a selecting means comprises the identification code switch 24 and the control circuit 25a.

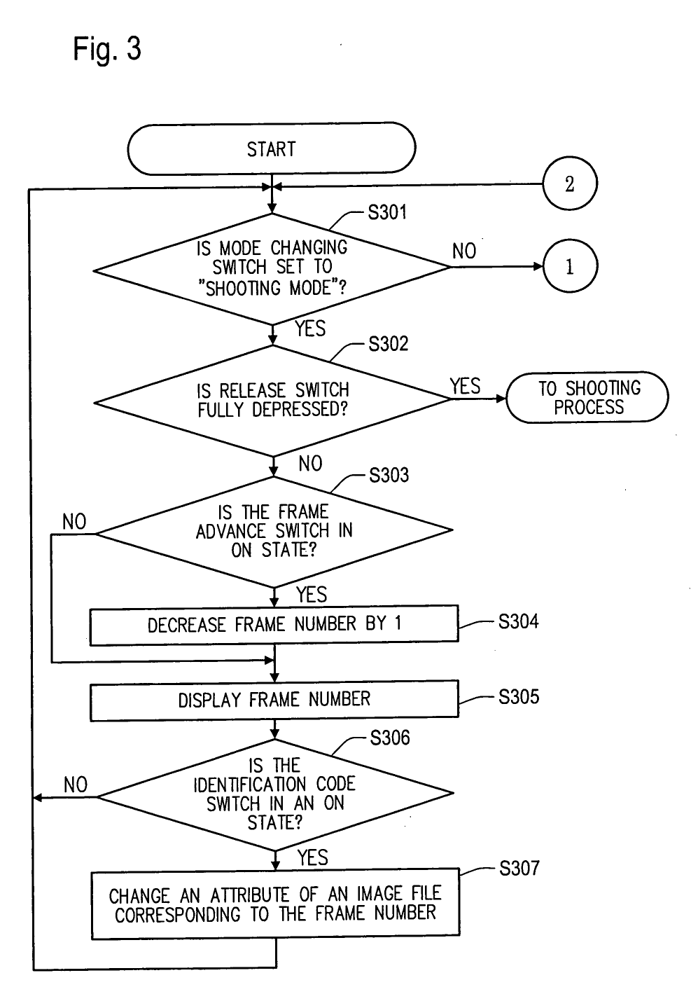

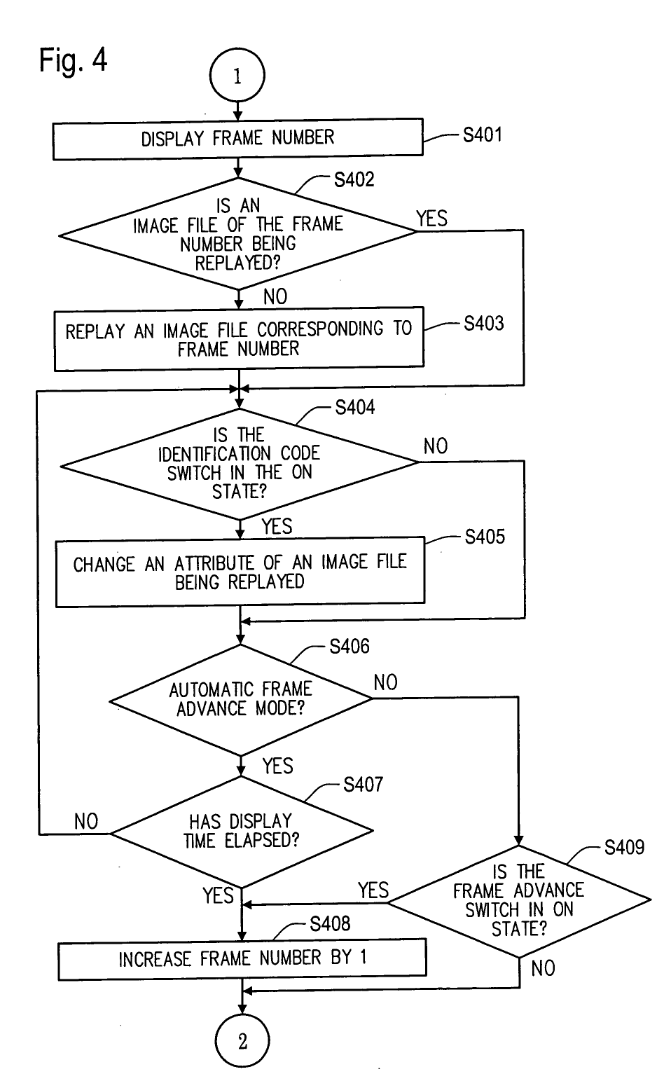

The operation of the present invention will now be described with regard to the flow charts shown in FIGS. 3 and 4.

In the electronic still camera of the present invention, when the mode changing switch 22a is set at a “shooting mode” (Step S301), the control circuit 25a determines the state of the release switch 21 (Step S302).

In the release switch 21, a 2-step connection comprising “half depression” and “full depression” is provided. In film cameras or the like, electric power is turned on to the entire body of the camera when the switch is half depressed to make the camera ready for shooting operations. The shutter release is then executed when the release switch 21 is fully depressed.

However, with the electronic still camera 10a of the present invention, when release switch 21 is half depressed, electric power is not turned on for circuits which are required only at the time of shooting, such as the image pick-up unit or the A/D converter. The electric power is turned on for those circuits only when fully depressed, resulting in a savings of power.

Therefore, when the release switch 21 is fully depressed, the control circuit 25a commences a normal shooting operation after electric power is supplied to those circuits that are required only at the time of shooting.

On the other hand, when the release switch is not fully depressed, the following operations can be commenced.

When the frame advance switch 23 is turned on (the frame advance switch 23 is controlled to be in an ON state) (Step S303), the control circuit 25a decreases a value of a frame number at that point by one (Step S304), and displays a new frame number (Step S305).

When the identification code switch 24 is turned on (the identification code switch 24 is controlled to be in an ON state) (Step S306), the control circuit 25a updates (rewrites/renews) a file attribute for the image data corresponding to the frame number.

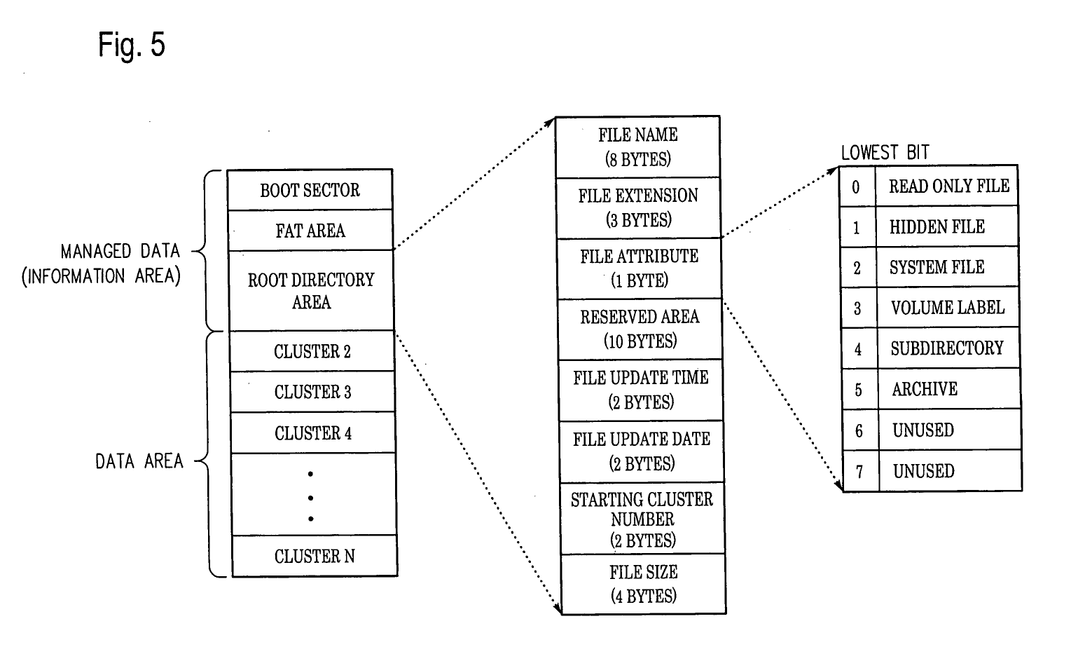

The image data in the memory card 17 is recorded in a specified file format as shown in FIG. 5. At this point, by setting “1” to the lowest bit of data containing a file attribute of the image data (1 byte in a managed data (information) area), attributes of the file are changed. (Step S307).

By returning to Step S301 to repeat the above operation, distinction of image data when operating in the shooting mode can be immediately (quickly) accomplished.

In the electronic still camera of the present invention, when the mode changing switch 22a is set in “replay mode”, the control circuit 25a displays the frame number (Step S401) and transfers and replays the image data corresponding to the frame number onto the frame memory 14 (Steps S402 and S403).

In this state, if the identification code switch 24 is turned on (the identification code switch 24 is controlled to be in an ON state) (Step S404), the control circuit 25a changes an attribute of the image data being replayed (Step S405).

Here, if the mode changing switch 22a is set to the “automatic frame advance mode” (Step S406), after a specified display time is elapsed (Step S407), the frame number is increased by 1 (Step S408), and the process returns to Step S401 to repeat the above operation.

On the other hand, if the mode changing switch 22a is set to the “manual frame advance mode” (Step S406), the frame number is increased by 1 as the frame advance switch 23 is depressed (when the frame advance switch 23 is depressed) (Step S409), and the process returns to Step S401 to repeat the above operation.

As described above, distinction of image data when operating in the replay mode can be immediately (quickly) accomplished.

With the above operations, because image data is appropriately selected and the attribute is changed to that of a “read-only” file, the image data is quickly organized later based on the file attributes.

For example, in an operating system using the above file formats, by conducting a batch deleting process for the image data in the memory card 17, only image data whose attributes have been changed to that of a “read-only file” can be selectively saved.

Moreover, by only rewriting the file attributes of the image data, the process is quickly completed without having to move the image data, delete the image data, or the like.

In addition, because the file attributes of the image data are immediately changed in accordance with the success (result) of the shooting images when in the shooting mode, no time is needed to replay the image data one by one later to determine the results of the shooting as in the conventional electronic still cameras. Accordingly, division of the image data is efficiently and intuitively accomplished in parallel with the shooting operations.

Moreover, in the shooting mode, because the image data is not replayed one by one, the time required for replaying the image data is saved, and the image data can be quickly and efficiently distinguished.

Furthermore, in the shooting mode, the frame advance switch 23, which is used during replay mode, can also be used (has a combined use) in the shooting mode as a control member to change the frame number. Thus, the number of the control members is kept to a minimum.

In the replay mode, because the image data is selected while confirming (looking at) the image data being replayed, the image data can be accurately distinguished.

In addition, in the electronic still camera 10a, because the file attributes are rewritten in accordance with the specified file formats, the selection of the image data can be simply and generally accomplished if an external device using the same file formats is used.

In the embodiment of the present invention as described above, an attribute of the image data is changed to that of a “read-only file.” However, this embodiment is not limited to the “read-only file” attribute. The image data can be distinguished by changing the attribute to any of the file attributes.

For instance, the attribute can be changed to be a “hidden file” or a “system file.” Since file names or the like will not be shown (displayed) with such changes in the attributes, files for the objective (desired) image data can be retained by deleting only the displayed files.

In the embodiment described above, the file attributes of the image data were changed. However, the present invention is not limited to changing the file attributes to accomplish the objectives of the invention. File names or file extensions can also be changed.

For example, when the name of the image data is “DSC00001.JPG,” the file name can be changed to “DDD00001.JPG,” or the file extension can be changed to “DSC0001.JJJ.” The image data whose name or extension is changed as described can be selected as a group by using a wildcard or a regular expression.

While this invention has been described in conjunction with specific embodiments thereof, it is evident that many alternatives, modifications and variations will be apparent to those skilled in the art. Accordingly, the preferred embodiments of the invention as set forth herein are intended to be illustrative, not limiting. Various changes may be made without departing from the spirit and scope of the invention as defined in the following claims.

What is claimed is:

1. An electronic still camera, comprising:
optical means for forming an object image;
image pick-up means for photoelectrically converting an object image, formed by said optical means, to image data;
recording means for recording the image data corresponding to an object image as an image data file to a recording medium based on a specified file format; and
selecting means for selecting an image data file to be a selected image data file by changing a portion of the image data file.

2. The electronic still camera according to claim 1, wherein said selecting means is capable of changing at least one of the file name, the file extension and the file attributes of an image data file to select the image data file.

3. The electronic still camera according to claim 2, wherein said selecting means comprises:
frame advance means for increasing and decreasing a frame number when a first external operation is performed; and
manual selection means for selecting an image data file corresponding to a frame number as the selected image data file when a second external operation is performed.

4. The electronic still camera according to claim 2, further comprising replaying means for replaying a plurality of image data files recorded in said recording medium, one by one;
wherein said selecting means selects an image data file being replayed by said replaying means as said selected image data file when an external operation is performed.

5. The electronic still camera according to claim 1, wherein said selecting means comprises:
frame advance means for increasing and decreasing a frame number when a first external operation is performed; and
manual selection means for selecting an image data file corresponding to a frame number as the selected image data file when a second external operation is performed.

6. The electronic still camera according to claim 1, further comprising replaying means for replaying a plurality of image data files recorded in said recording medium, one by one;
wherein said selecting means selects an image data file being replayed by said replaying means as said selected image data file when an external operation is performed.

7. An electronic still camera, comprising:
an optical device for forming an image;
an image pick-up device for changing the image formed by said optical device to image data;
a recording device for recording the image data corresponding to an object image as an image data file to a recording medium based on a specified file format; and
a selecting device for selecting an image data file to be a selected image data file by changing a portion of the image data file.

8. The electronic still camera according to claim 7, wherein said selecting device is capable of changing at least one of the file name, the file extension and the file attributes of an image data file to select the image data file.

9. The electronic still camera according to claim 8, wherein said selecting device comprises:
a frame advance device for increasing and decreasing a frame number when a first external operation is performed; and
a manual selection device for selecting an image data file corresponding to a frame number as the selected image data file when a second external operation is performed.

10. The electronic still camera according to claim 8, further comprising a replaying device for replaying a plurality of image data files recorded in said recording medium, one by one;
wherein said selecting device selects an image data file being replayed by said replaying device as said selected image data file when an external operation is performed.

11. The electronic still camera according to claim 7, wherein said selecting device comprises:
a frame advance device for increasing and decreasing a frame number when a first external operation is performed; and
a manual selection device for selecting an image data file corresponding to a frame number as the selected image data file when a second external operation is performed.

12. The electronic still camera according to claim 7, further comprising a replaying device for replaying a plurality of image data files recorded in said recording medium, one by one;
wherein said selecting device selects an image data file being replayed by said replaying device as said at least one selected image data file when an external operation is performed.

13. A method for managing image data in an electronic still camera, comprising the steps of:
providing an optical device to form an image;
changing the image formed by said optical device to image data;
recording the image data of an image as a data file, with file attribute data, to a recording medium based on a specified file format; and
selecting at least one image data file by changing a portion of the image data file.

14. The method according to claim 13, wherein the step of selecting at least one image data file comprises changing at least one of a file name, a file extension and a file attribute of the at least one selected image data file.

15. The method according to claim 14, further comprising the step of increasing or decreasing a frame number by performing a first external operation; and
wherein the selecting step is performed on an image data file corresponding to a current frame number when a second external operation is performed.

16. The method according to claim 14, further comprising the step of replaying an image data file recorded in said recording medium; and
wherein said selecting step is performed on an image data file being replayed by said replaying device when an external operation is performed.

17. The method according to claim 13, further comprising the step of increasing or decreasing a frame number when a first external operation is performed; and
wherein the selecting step is performed on an image data file corresponding to a current frame number when a second external operation is performed.

18. The method according to claim 13, further comprising replaying an image data file recorded in said recording medium; and
wherein said selecting step is performed on an image data file being replayed by said replaying device when an external operation is performed.
